(19) United States
(12) Patent Application Publication
(10) Pub. No.: US 2006/0006648 A1
(43) Pub. Date: Jan. 12, 2006

(54) Tubular goods with threaded integral joint connections

(76) Inventors: Harold Michael Grimmett, Hughes Springs, TX (US); Edmond L. Miller, New Boston, TX (US); Bluford W. Lowery, Linden, TX (US); Mitchell Bryan Mattox, Lone Star, TX (US); Bowman A. Urech, Plano, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/227,399

(22) Filed: Sep. 15, 2005

Related U.S. Application Data
(63) Continuation-in-part of application No. 10/382,625, filed on Mar. 6, 2003.
(62) Division of application No. 10/828,069, filed on Apr. 20, 2004.
Application No. 10/828,069 is a division of application No. 10/382,625, filed on Mar. 6, 2003.
(60) Provisional application No. 60/610,321, filed on Sep. 16, 2004.
(60) Provisional application No. 60/620,182, filed on Oct. 19, 2004.

(51) Int. Cl. F16L 25/00

(52) U.S. Cl. 285/333

(57) ABSTRACT

Oil country tubular goods and other types of tubular members are provided with integral joints having threaded connections. The integral joints may be flush type connections or swage type connections. The tubular members may be formed using electric resistant welding technology satisfactory for radial expansion within a wellbore. The threaded connections may be used to join sections of casing with each other to form a casing string to complete a wellbore.

### RELATED APPLICATION

This application claims the benefit of U.S. Provisional Patent Application entitled “Tubular Goods With Threaded Integral Joint Connections”, Ser. No. 60/610,321 filed, Sep. 16, 2004, the contents of which are hereby incorporated by reference in their entirety.

This application claims the benefit of U.S. Provisional Patent Application entitled “Tubular Goods With Threaded Integral Joint Connections”, Ser. No. 60/620,182 filed, Oct. 19, 2004, the contents of which are hereby incorporated by reference in their entirety.

This application is a U.S. Continuation-In-Part patent application based on pending application entitled “Tubular Goods With Expandable Threaded Connections” Ser. No. 10/382,625, filing date Mar. 6, 2003 entitled “Tubular Goods With Expandable Threaded Connections” now U.S. Pat. No. ______.

This application is a copending application to the divisional patent application entitled, “Tubular Goods with Expandable Threaded Connections”, Ser. No. 10/828,069, filed Apr. 20, 2004, which is a divisional application of the patent application entitled “Tubular Goods With Expandable Threaded Connections”, Ser. No. 10/382,625, filing date Mar. 6, 2003 entitled “Tubular Goods With Expandable Threaded Connections” now U.S. Pat. No. ______.

### TECHNICAL FIELD

The present invention is related to tubular members and more particularly to oil country tubular goods having integral joints with threaded connections.

### BACKGROUND OF THE INVENTION

Wellbores for producing oil, gas or other fluids from selected subsurface formations, are typically drilled in stages. For example, a wellbore may be drilled with a drill string and a first drill bit having a first diameter. At a desired depth for a first portion of the wellbore, the drill string and drill bit are removed from the wellbore. Tubular members of smaller diameter, often referred to as casing or a casing string, placed in the first portion of the wellbore. An annulus formed between the inside diameter of the wellbore and the outside diameter of the casing is filled with cement. The cement provides support for the casing and isolates subsurface formations or strata from each other. Many wellbores are completed with relatively large diameter casing located near the well surface and smaller diameter casing extending therefrom in a telescoping or stair step pattern to a downhole location.

Very deep and/or very long wells, sometimes referred to as extended reach wells (20,000 feet or greater), may have three or four changes in casing diameter from the well surface to total depth of the wellbore. Each change in casing diameter often results in decreasing the diameter of associated production tubing used to produce formation fluids. Changes in casing diameter associated with deep wells and/or long wells often result in significantly increased drilling and well completion costs. A number of oil and gas wells have been completed using solid, expandable casing. Electric resistant welded (ERW) pipe has frequently been used to form such casing.

### SUMMARY OF THE INVENTION

In accordance with teachings of the present invention, solid, radially expandable tubular goods with threaded connections are provided to complete wellbores. One aspect of the present invention includes providing threaded connections which may be used with integral joints to releasably engage tubular goods with each other and to accommodate downhole, radial expansion of the tubular goods during completion of a wellbore. The threaded connections and associated integral joints preferably maintain desired fluid tight seals and mechanical strength after such radial expansion. Integral joints and associated threaded connections formed in accordance with teachings of the present invention may also be used with tubular goods which are not designed for radial expansion in a wellbore.

Tubular members may be formed with either flush type integral joints or swage type integral joints having threaded connections formed in accordance with teachings of the present invention. Each threaded connection may include a pin end of a first tubular member and a box end of a second tubular member releasably engaged with each other. For some applications the threaded connections may include modified buttress type thread forms or thread profiles with positive stab flank angles and negative load flank angles. The tubular members and associated threaded connections may be formed using materials and techniques selected to allow radial expansion at downhole locations in a wellbore.

For some well completions the pin end and box end of each tubular member may be formed with substantially the same nominal outside diameter. The combined wall thickness of each threaded connection may be substantially the same as the nominal wall thickness of the tubular members. A string or series of tubular members releasably engaged with each other by threaded connections formed in accordance with teachings of the present invention may have a generally uniform inside diameter and a generally uniform outside diameter. Such threaded connections may be described as “flush joints.”

For other well completions each tubular member may be formed with a box end having a nominal outside diameter larger than the nominal outside diameter of the associated tubular member. Each tubular member may have a pin end with a tapered outside diameter equal to less than the nominal outside diameter of the associated tubular member. The inside diameter of the box end of each tubular member is preferably selected to accommodate the tapered outside diameter of the pin end of another tubular member. The combined wall thickness of each threaded connection may be larger than the nominal wall thickness of the respective tubular members. A string or series of tubular members releasably engaged with each other by threaded connections formed in accordance of teachings of the present invention may have a generally uniform inside diameter except for a respective annular recess formed proximate each thread connection. The outside diameter of the string or series of tubular members may be relatively uniform except for the increased outside diameter of each box end proximate each threaded connection. Such threaded connections may sometimes be described as “swage joints.”

Technical benefits of the present invention include providing solid, radially expandable tubular members with threaded connections that substantially reduce or eliminate requirements for telescoping or tapering of a wellbore from an associated well surface to a desired downhole location. The threaded connections preferably maintain both desired mechanical strength and fluid tight integrity during radial expansion of the tubular members and associated threaded connections. Thread profiles formed in accordance with teachings of the present invention may be treated by blasting with fine grains of sand (sometimes referred to as sugar blasting) to reduce or minimize potential galling between threaded surfaces.

For some applications one or more thread profiles may be coated or plated with a layer of tin, tin alloys, zinc or other materials selected to help maintain fluid tight seals between respective thread profiles of associated pin members and box members. Heat and pressure generated during radial expansion of tubular members and associated threaded connections may cause such materials to flow into any void spaces resulting from expansion of the threaded connections.

For one embodiment each threaded connection may include thread profiles with five buttress type threads per inch and a taper of approximately three fourths of an inch per foot. For another embodiment each treaded connection may include thread profiles with six buttress type threads per inch and a taper of approximately one and one fourth inches per foot.

A pin end associated with each threaded connection may have a respective chamfer formed at an angle of approximately fifteen degrees (15°) and sized to satisfactorily engage a respective shoulder formed on the interior of an associated box end at a corresponding angle of approximately fifteen degrees (15°). Each thread form may have load flank angles of approximately minus five degrees or negative five degrees (−5°) and stab flank angles of approximately positive twenty-five degrees or plus twenty-five degrees (+25°).

For some embodiments each thread formed may have load flank angles of approximately minus five degrees or negative five degrees (−5°) and stab flank angles of approximately positive ten degrees or plus ten degrees (+10°). A pin end associated with each threaded connection may terminate with an end surface or extreme end extending approximately normal to the longitudinal axis of an associated first tubular member. A first chamfer may be formed on the inside diameter of each pin end proximate the respective extreme end. The pin end may be sized to satisfactorily engage an associated box end. A tapered sealing surface extending from the extreme end of each pin end may engage a corresponding tapered sealing surface formed within the associated box end for use in forming a fluid barrier disposed therebetween. The box end associated with each threaded connection may also terminate with an end surface or extreme end extending approximately normal to the longitudinal axis of an associated second tubular member. A second chamfer may be formed on the outside diameter of each box end proximate the extreme end. The extreme end of the box end may be sized to engage a respective shoulder disposed on the exterior of the first tubular member. The shoulder may be spaced longitudinally from the extreme end of the associated pin end.

Radially expandable tubular goods formed in accordance with teachings of the present invention may allow wells to be completed to relatively deep geological locations or at extended distances from a production platform which may have been difficult and/or expensive to reach using traditional well drilling and casing technology. The use of solid, radially expandable tubular goods with threaded connections may allow wellbores to be drilled and completed with only one size of casing extending from a well surface to a relatively deep downhole location and/or extended reach location. As a result of requiring only one or two sizes of casing to complete a wellbore, surface equipment, associated drilling rigs, drill strings and bit sizes may be standardized to significantly reduce costs.

For some applications tubular members with integral joint connections formed in accordance with teachings of the present invention may be radially expanded by as much as twenty percent (20%) of their original outside diameter and satisfactorily hold as much as three thousand five hundred pounds per square inch (3,500 psi) of internal fluid pressure after such expansion. Integral joint connections formed in accordance with teachings of the present invention may provide required mechanical strength to complete deep and/or extended reach wellbores and provide required fluid, pressure tight seals between the interior and the exterior of associated tubular members.

### BRIEF DESCRIPTION OF THE DRAWINGS

A more complete and thorough understanding of the present invention and advantages thereof may be acquired by referring to the following description taken in conjunction with the accompanying drawings, in which like reference numbers indicate like features, and wherein:

FIG. 1A is a schematic drawing in section and in elevation with portions broken away of a first tubular member having a pin end and a box end with respective threaded portions and sealing surfaces formed in accordance with teachings of the present invention;

FIG. 1B is an enlarged schematic drawing in section with portions broken away of the pin end of the tubular member of FIG. 1A;

FIG. 1C is an enlarged schematic drawing in section with portions broken away of the box end of the tubular member of FIG. 1A;

FIG. 2 is a schematic drawing in section with portions broken away showing a second tubular member aligned with the first tubular member of FIG. 1A prior to releasable engagement with each other in accordance with teachings of the present invention;

FIG. 3 is a schematic drawing in section with portions broken away showing the box end of the second tubular member releasably engaged with the pin end of the first tubular member in a hand tight position prior to forming a swage type integral joint connection;

FIG. 4 is a schematic drawing in section with portions broken away showing the box end of the second tubular member releasably engaged with the pin end of the first tubular member to form the swage type integral joint connection in accordance with teachings of the present invention;

FIG. 5A is a schematic drawing in section and in elevation with portions broken away showing a first tubular member having a pin end and a box end with respective threaded portions and sealing surfaces formed in accordance with teachings of the present invention;

FIG. 5B is an enlarged schematic drawing in section with portions broken away of the pin end of the tubular member of FIG. 5A;

FIG. 5C is an enlarged schematic drawing in section with portions broken away of the box end of the tubular member of FIG. 5A;

FIG. 6 is a schematic drawing in section with portions broken away of a second tubular member aligned with the first tubular member of FIG. 5A prior to releasable engagement with each other in accordance with teachings of the present invention;

FIG. 7 is a schematic drawing in section with portions broken away showing the box end of the second tubular member releasably engaged with the pin end of the first tubular member in a hand tight position prior to forming a flush type integral joint connection in accordance with the teachings of the present invention;

FIG. 8 is a schematic drawing in section with portions broken away showing the box end of the second tubular member releasably engaged with the pin end of the first tubular member in a power tight position to form the flush type integral joint connection;

FIG. 9 is a schematic drawing in section with portions broken away showing an enlarged view of a threaded connection with at least one threaded portion having a layer of tin or other malleable coating disposed thereon in accordance with teachings of the present invention; and

FIG. 10 is a schematic drawing in section with portions broken away showing an enlarged view of the threaded connection of FIG. 9 after radial expansion.

### DETAILED DESCRIPTION OF THE INVENTION

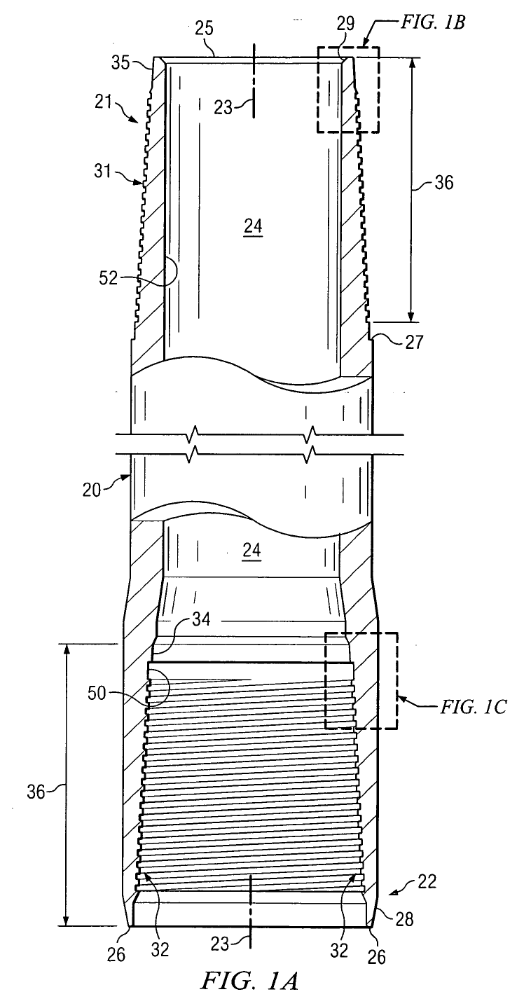

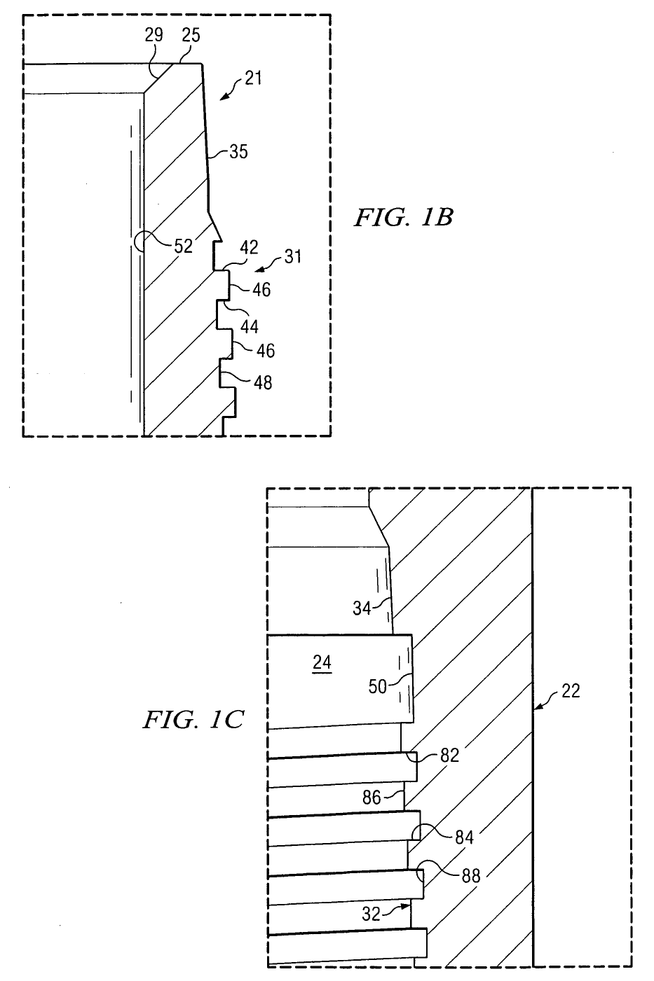

Preferred embodiments of the invention and its advantages are best understood by reference to FIGS. 1A-10 wherein like numbers refer to same and like parts.

The terms “oil country tubular goods” and “OCTG” are used in this application to include casing, tubing, pup joints, couplings and any other type of pipe or tubular member associated with drilling, producing or servicing oil wells, natural gas wells, geothermal wells or any other subsurface wellbore. Threaded connections incorporating teachings of the present invention may be formed on a wide variety of oil country tubular, both expandable and nonexpandable goods.

The terms “welded pipe” and “welded tubular goods” are used in this application to include any pipe, tubular member or coupling manufactured from flat rolled steel or steel strips which passed through equipment designed to create a longitudinal butt joint and was welded along the longitudinal butt joint. A line of forming rollers may be used to create such longitudinal butt joints. The resulting longitudinal butt weld or longitudinal seam weld may be formed using various techniques such as electric resistance welding (ERW), arc welding, laser welding, high frequency induction welding and any other techniques satisfactory for producing longitudinal seam welds. Welded pipe and welded tubular goods may be produced in individual links or may be produced in continuous links from coiled skelp and subsequently cut into individual links.

The terms “flush joint” and “flush type connection” are used in this application to describe a threaded connection formed between two, hollow tubular members with both tubular members having approximately the same nominal outside diameter, inside diameter and wall thickness. The outside diameter, inside diameter and combined wall thickness of the threaded connection are also approximately equal to the corresponding dimensions of the tubular members.

The terms “swage joint” and “swage type connection” may be used in this application to describe a threaded connection formed between two, hollow tubular members. Each tubular member may have a respective box end and pin end. Each box end may have an outside diameter larger than a nominal outside diameter of the associated tubular member. The interior dimensions and configuration of each box end are preferably selected to be compatible with corresponding exterior dimensions and configuration of an associated pin end. The outside diameter of the resulting threaded connection will generally be larger than the nominal outside diameter of the associated tubular members. The inside diameter of the threaded connection will generally be approximately equal to the nominal inside diameter of the associated tubular members except for an annular recess which may be formed proximate the extreme end of the associated pin end. The combined wall thickness of the threaded connection may be larger than the nominal wall thickness of the associated tubular members.

The term “integral joint” may be used to describe a threaded connection formed between two hollow tubular members without the use of a coupling or any other device. Examples of such integral joints include, but are not limited to, threaded flush joints and threaded swage joints.

Various aspects of the present invention will be described with respect to radially expandable tubular members which have been formed using electric resistant welding (ERW) technology. However, the present invention is not limited to use with radially expandable tubular members produced by ERW technology. A wide variety of other tubular members and oil country tubular goods (OCTG) may be releasably engaged with each other by threaded connections formed in accordance with teachings of the present invention.

ERW technology often allows better quality control of wall thickness associated with welded pipe and minimizes material defects. Tubular members formed in accordance with teachings of the present invention from ERW pipe may have better performance characteristics, such as mechanical strength and fluid tight integrity, after radial expansion as compared with tubular members formed from seamless pipe. However, threaded connections and integral joints formed in accordance with teachings of the present invention are not limited to use on tubular goods formed from ERW pipe.

Various aspects of the present invention will be discussed with respect to tubular members 20 and 120 as shown in FIGS. 1A-10. To describe some features of the present invention, tubular members 20 and 120 may sometimes be designated as 20a, 20b, 120a and 120b.

For some applications, tubular members 20 and 120 may be sections of a casing string used to complete a wellbore (not expressly shown). Tubular members 20 and 120 may have some overall dimensions and configurations compatible with a conventional oil field casing string. For other applications, various types of downhole well completion tools (not expressly shown) may have threaded portions corresponding with threaded portions of tubular members 20 and/or 120. For example, a liner hanger (not expressly shown) may be formed with a pin end and/or a box end having dimensions corresponding respectively with the pin end or the box end of tubular members 20 or 120.

FIGS. 1A-10 generally show pin end 21 of tubular members 20 and pin end 121 of tubular members 120 in an “up” position and box 22 of tubular members 20 and box end 122 of tubular member 120 in a “down” position. Generally, tubular members such as drill strings, casing and production tubing are inserted or run into a wellbore with the box end looking up and the pin end directed down. Box end “up” is often preferred for making and breaking threaded connections associated with OCTG. As discussed later in more detail, tubular members 20 and 120 may be oriented with respective pin ends 21 and 121 in an “up” position to aid in radial expansion of tubular member 20 and 120 at a selected downhole location in a wellbore. However, tubular goods having threaded connections incorporating teachings of the present invention may be installed in a wellbore with either box end “up” or pin end “up” as required for each well completion.

Threaded portions 31 and 131 formed on respective pin ends 21 and 121 preferably have external thread profiles. Threaded portions 32 and 132 formed within respective box ends 22 and 122 preferably have internal thread profiles which may be releasably engaged with another tubular member having a pin end with threaded portion 31 or 131. Threaded portions 31, 32, 131 and 132 may have thread forms or thread profiles similar to American Petroleum Institute (API) buttress threads for oil country tubular goods. API Specification Standard SB contains information for various types of threads associated with OCTG.

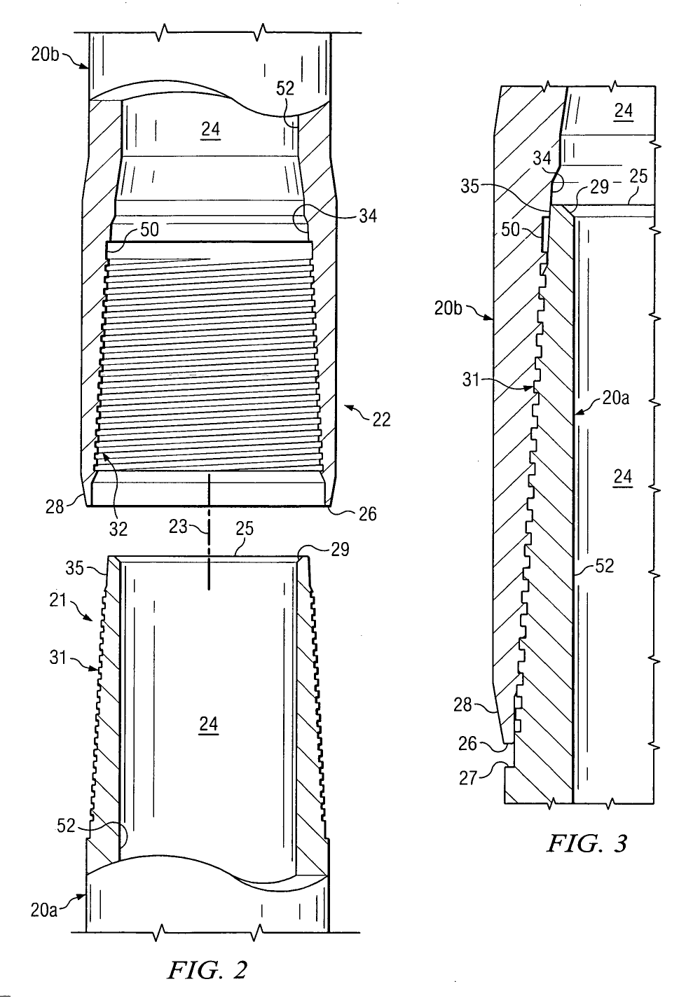

For some embodiments of the present invention as shown in FIGS. 1A-10, threaded portions 31, 32, 131 and 132 may be generally described as having modified buttress thread forms. Threaded portions 31, 32, 131 and 132 formed in accordance with teachings of the present invention preferably include several significant differences as compared with more conventional buttress thread forms. For example, thread forms or thread profiles associated with threaded portions 31, 32, 131 and 132, preferably having negative load flank angles and positive stab flank angles. The tapered thread profiles associated with threaded portions 31, 32, 131 and 132 and the positive flank angles cooperate with each other to facilitate makeup of box end 22 with associated pin end 21 and the makeup of box end 122 with associated pin end 121. See FIGS. 2, 3 and 4 and FIGS. 6, 7 and 8.

First flank angles or stab flank angles formed in accordance with teachings of the present invention may vary between approximately positive ten degrees (+10°) and positive forty-five degrees (+45°). Threaded connections formed in accordance with teachings of the present invention may have second flank angles or load flank angles between approximately negative three degrees (−3°) and negative fifteen degrees (−15°).

Various features of tubular goods and threaded connections formed in accordance with teachings of the present invention allow radial expansion of the tubular goods and associated threaded connections while maintaining desired mechanical strength and fluid tight integrity. These features include negative load flank angles 44 and 84 which retain close, intimate contact between associated threaded portions 31, 32, 131 and 132 during radial expansion of tubular members 20. The negative angle of the load flanks may be selected in accordance with teachings of the present invention to provide desired tensile strength to prevent disengagement of associated threaded portions 31, 32, 131 and 132 during radial expansion.

FIG. 1A shows tubular member 20 which may be formed using electric resistance welding (ERW) technology. For this embodiment, tubular member 20 may be generally described as an elongated, hollow section of casing. Tubular member 20 includes first end or pin end 21 and second end or box end 22 with longitudinal bore 24 extending therethrough. Longitudinal bore 24 may be defined in part by longitudinal axis 23 and inside diameter 52. Threaded portions 31 and 32 incorporating teachings of the present invention are preferably formed on respective pin end 21 and box end 22 of each tubular member 20.

Tubular members 20 may be initially formed with blank ends (not expressly shown). One end of each tubular member 20 may be swaged to form an enlarged outside diameter and an enlarged inside diameter corresponding with overall dimensions associated with box end 22. Various swaging techniques may be satisfactorily used to form box end 22 on one end of each tubular member 20. During the swaging process the outside diameter and the inside diameter of box end 22 will generally be increased as compared with other portions of associated tubular member 20. The inside diameter of pin end 21 will generally remain the same as inside diameter 52 of tubular member 20. The nominal wall thickness of box end 22 will generally remain approximately the same as the nominal wall thickness of tubular member 20. Swaging techniques may be particularly beneficial for use with radially expandable tubular members.

As shown in FIG. 1B thread forms associated with threaded portion 31 may include first flank or stab flank 42 and second flank or load flank 44 extending between respective thread crests 46 and thread roots 48. In a similar manner as shown in FIG. 1C, thread forms associated with threaded portion 32 include first flank or stab flank 82 and second flank or load flank 84 extending between respective thread crests 86 and thread roots 88. For some applications, first flanks or stab flanks 42 and 82 may be formed at an angle of approximately positive ten degrees (+10°) relative to a plane disposed normal to longitudinal axis 23 of longitudinal bore 24. Second flanks or load flanks 44 and 84 may be formed at an angle of approximately negative five degrees (−5°) relative to the same plane.

For some applications thread roots 88 of threaded portion 32 may be larger (for example 0.001 inches) than thread crests 46 of threaded portion 31 to accommodate redistribution and flow of coating 100 during both power tight make up of associated threaded connections and downhole radial expansion of tubular members 20. See FIGS. 9 and 10. The height of thread crests 46 and 86 may be reduced to increase the mechanical strength of the associated threaded connection. For example thread crests 46 and 86 may have a height of approximately 0.052 inches as compared with more typical buttress thread heights of 0.062 inches.

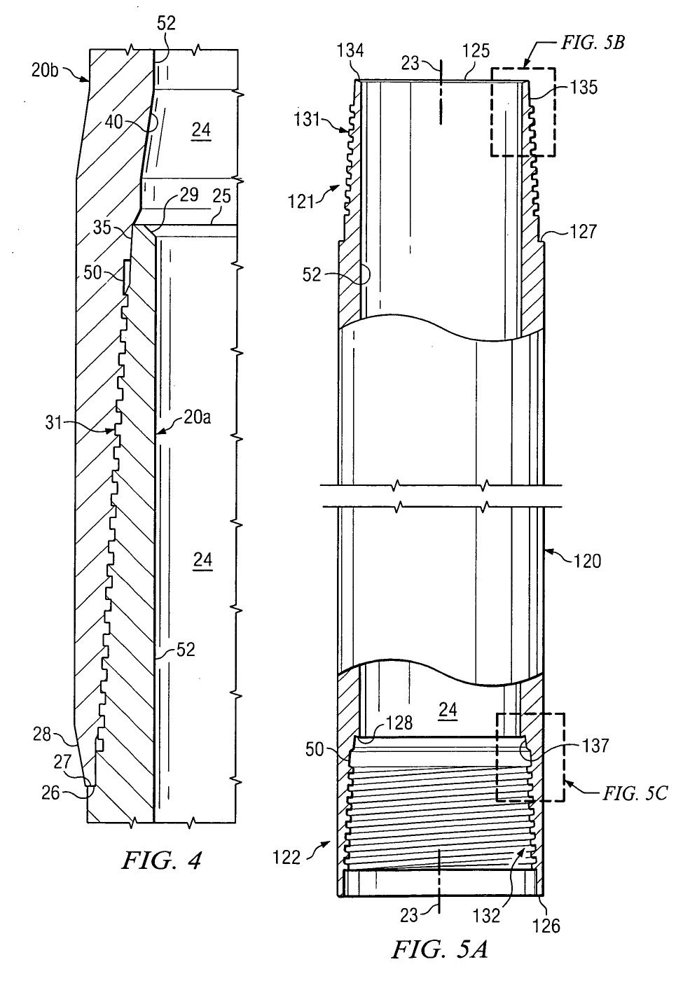

Box end 22 may be formed by swaging portions of each tubular member 20 starting from extreme end 26 to provide desired overall dimensions of length, outside diameter, inside diameter and wall thickness. Threaded portion 32 may be formed between extreme end 26 and enlarged recess 50. Enlarged recess 50 may sometimes be described as a “grease trap” which receives any excess thread dope or grease placed on threaded portions 31 or 32. Enlarged recess 50 may be particularly helpful to receive excess thread dope or grease during make up of threaded connections such as shown in FIG. 4. Threaded portion 32 may terminate proximate enlarged recess 50. Chamfer 28 may be formed on the outside diameter of box end 22 adjacent to extreme end 26. Chamfer 28 may sometimes be formed at an angle of approximately eighty degrees (80°) relative to longitudinal axis 23. Tapered sealing surface 34 may be formed on the inside diameter of box end 22 adjacent to enlarged recess 50.

For some applications, threaded portion 32, enlarged recess 50 and tapered sealing surface 34 may be formed by a single pass of a thread cutting machine (not expressly shown) extending through end 26 of longitudinal bore 24 to form interior portions of box end 22. Enlarged recess 50 may accommodate withdrawal of an associated thread cutting tool depending upon the design and configuration of the specific thread cutting tool.

As shown in FIGS. 1A and 1B, pin end 21 may include extreme end 25, threaded portion 31 and shoulder 27 disposed on the exterior of associated tubular member 20. Extreme end 25 of pin end 21 may extend generally normal to associated longitudinal axis 23. Chamfer 29 may be formed on the interior of pin end 20 adjacent to extreme end 25. For some applications chamfer 29 may extend at an angle of approximately forty-five degrees (450) relative to associated longitudinal axis 23. Shoulder 27 may also extend generally normal to associated longitudinal axis 23. Shoulder 27 is preferably sized to engage extreme end 26 of associated box end 22.

The inside diameter of box end 22 will generally be enlarged as compared with inside diameter 52 of associated pin end 21. The dimensions of each pin end 21 and box end 22 are preferably selected such that inside diameter 52 of pin end 21 of tubular member 20a will be generally aligned with inside diameter 52 of tubular member 20b when pin end 21 has been engaged with associated box end 22. See FIGS. 2, 3 and 4. Annular recess 40 may be formed within each threaded connection proximate extreme end 25 of respective pin end 21. Chamfer 29 may be provided on pin end 21 to minimize any interference with movement of well tools or drift check tools (not expressly shown) through longitudinal bores 24. Extreme end 25 and adjacent portions of pin end 21 may be deflected towards longitudinal axis 32 during make up with associated box end 22.

Tubular members 20a and 20b formed in accordance with the teachings of the present invention are shown releasably engaged with each other in FIGS. 3 and 4. Tubular members 20a and 20b may be formed from ERW pipe having substantially the same nominal outside diameter, inside diameter and wall thickness. Each box end 22 may have a larger outside diameter as compared to other portions of respective tubular members 20a and 20b. As a result, when box end 22 of tubular member 20b is releasably engaged with pin end 21 of tubular member 20a, the resulting threaded connection may be described as “swage joint” with respect to the outside diameter of box end 22 being larger than the adjacent outside diameter of tubular member 20a. Inside diameter 52 of respective longitudinal bores 24 and pin end 21 are substantially equal. See FIGS. 3 and 4.

FIG. 2 shows a typical orientation of first tubular member 20a and second tubular member 20b prior to making up tubular members 20a and 20b for insertion into a wellbore (not expressly shown). The present invention allows multiple tubular members 20 to be releasably engaged with each other to form a casing string to complete a wellbore. First tubular member 20a may be positioned on a drilling platform or well servicing platform (not expressly shown) over a wellbore with pin end 21 looking up to receive box end 22 of second tubular member 20b. Various types of pipe tongs and other powered equipment associated with making and breaking threaded connections between oil country tubular goods may be satisfactorily used to releasably engage box end 22 of second tubular member 20b with pin end 21 of first tubular member 20a. For purposes of describing various features of the present invention, the process of making up or releasably engaging box end 22 of tubular member 20b will be described with respect to pin end 21 of tubular member 20a.

Threaded portions 31 and 32 may have approximately the same length 36. Length 36 for threaded portion 31 may be measured from extreme end 25 of pin end 21 to shoulder 27 formed on the exterior of tubular member 20. Length 36 of threaded portion 32 of each tubular member 20 may be measured from extreme end 26 to a plane extending generally normal to longitudinal axis 23 proximate the end of tapered sealing surface 34 opposite from associated enlarged recess 50. See FIG. 1A. Length 36 of threaded portions 31 and 32 for tubular members 20a and 20b may be selected so that extreme end 26 of box end 22 will abut shoulder 27 of associated pin end 21 and tapered sealing surface 35 of pin end 21 will preferably be engaged with tapered sealing surface 34 of box end 22. See FIGS. 3 and 4.

Threaded connections as shown in API Specification Standard 5B may be made up to a “basic hand-tight position” and to a “basic power-tight position” as indicated by markings on the exterior of associated oil country tubular goods. The hand tight position for box end 22 of tubular member 20b relative to pin end 21 of tubular member 20a is shown in FIG. 3.

For some applications threaded portions 31 and 32 may have matching thread profiles with at least five (5) threads per inch. For other applications threaded portions 31 and 32 may have six (6) threads per inch. Various dimensions associated with threaded portions 31 and 32 may be selected to provide a hand tight position defined in part by a stand off of approximately two (2) threads between extreme end 25 of tubular member 20a and shoulder 28 of tubular member 20b. See FIG. 3.

Examples of dimensions associated with threaded connections having a hand tight position with a two thread stand off are shown in Tables 1 and 2. A typical stand off for threaded connections associated with oil country tubular goods that have a hand tight position may often be one thread or less. The two thread stand off in the hand tight position assists in maintaining mechanical integrity and fluid tight or pressure tight integrity of the associated threaded connection during radial expansion.

For some applications, relatively smooth nonthreaded portion or tapered sealing surface 35 may be formed as part of threaded portion 31 extending from extreme end 25 of each pin end 21. Relatively smooth nonthreaded portion or tapered sealing surface 34 may also be formed within box end 22 extending from enlarged recess 50. Sealing surfaces 34 and 35 may form a “tapered” metal to metal seal or fluid barrier disposed therebetween. For some applications, sealing surfaces 34 and 35 may extend at a taper approximately equal to the taper of associated thread profiles 31 and 32.

Metal to metal contact may be formed between tapered sealing surfaces 34 and 35 when threaded portions 31 and 32 have a standoff of two threads. Further tightening of threaded portions 31 and 32 may result in deflection of pin end 121 by approximately 0.025 inches proximate tapered sealing surface 35. An enhanced metal to metal seal or fluid barrier may be formed between sealing surfaces 34 and 35 as a result of the deflection.

Engagement between tapered sealing surface 34 of box end 22 and tapered sealing surface 35 of box end 21 may result in improved performance of associated threaded connections during radial expansion of tubular members 20a and 20b at a down hole location within a wellbore. When an expansion mandrel or similar tool moves through longitudinal bores 24, direct contact between nonthreaded portions 34 and 35 will result in radial expansion without disengagement of associated threaded portions 34 and 35. For some applications, nonthreaded portions 34 and 35 may have a length of approximately one (1) inch or more. Nonthreaded portions 34 and 35 cooperate with each other to coordinate radial expansion of pin end 21 with box end 22 during deformation of the associated threaded connections.

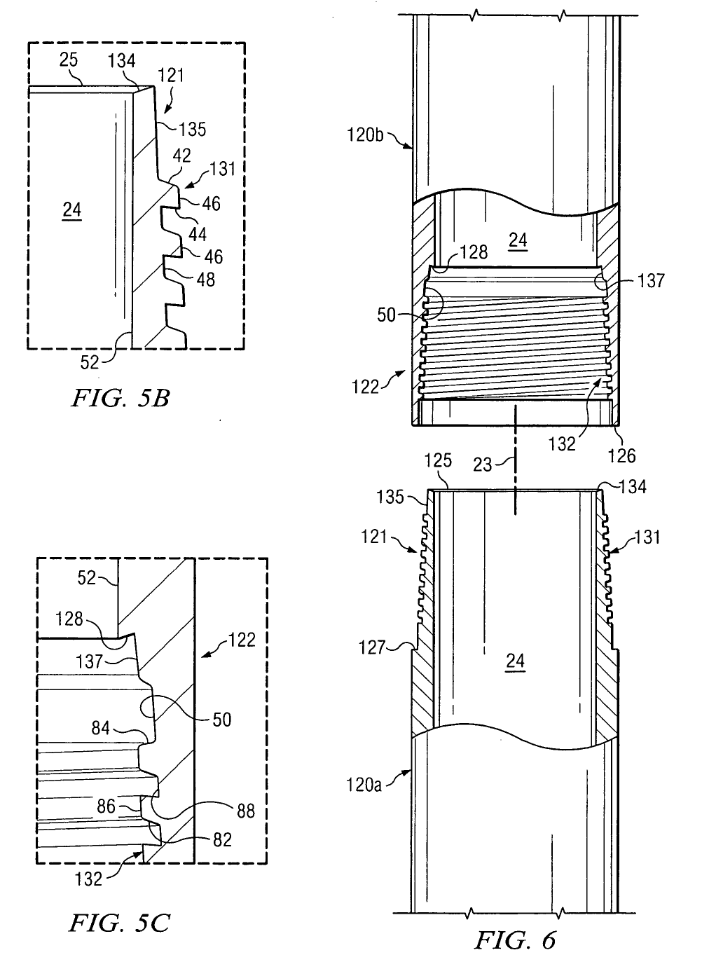

FIG. 5A shows tubular member 120 which may be formed using electric resistance welding (ERW) technology. For this embodiment, tubular member 120 may be generally described as an elongated, hollow section of casing. Tubular member 120 includes first end or pin end 121 and second end or box end 122 with longitudinal bore 24 extending therethrough. Longitudinal bore 24 may be defined in part by longitudinal axis 23 and inside diameter 52. Tubular members 120 may be initially formed with blank ends (not expressly shown). Respective threaded portions 131 and 132 incorporating teachings of the present invention may then be formed on pin end 121 and box end 122 using conventional pipe threading machines and equipment (not expressly shown). Threaded portions 131 and 132 may have similar dimensions and configurations as described for threaded portions 31 and 32 of tubular members 20. For other applications the dimensions and configuration of threaded portions 131 and 132 may be modified in accordance with teachings of the present invention.

As shown in FIG. 5B thread forms associated with threaded portion 131 may include first flank or stab flank 42 and second flank or load flank 44 extending between respective thread crests 46 and thread roots 48. In a similar manner as shown in FIG. 5C, thread forms associated with threaded portion 132 include first flank or stab flank 82 and second flank or load flank 84 extending between respective thread crests 86 and thread roots 88. For some applications, first flanks or stab flanks 42 and 82 may be formed at an angle of approximately positive twenty-five degrees (+25°) relative to a plane disposed normal to longitudinal axis 23 of longitudinal bore 24. Second flanks or load flanks 44 and 84 may be formed at an angle of approximately negative five degrees (−5°) relative to the same plane.

As discussed later in more detail, pin end 121 may include first shoulder 127 sized to engage extreme end 126 of box end 121 of an associated tubular member 120. See FIG. 8. Second shoulder 128 may be formed in box end 122 with enlarged recess 50 disposed between second shoulder 128 and threaded portion 132. Threaded portion 132 may terminate proximate enlarged recess 50. Shoulder 128 in box end 122 may have a negative angle compatible with chamfer 134 having a positive angle formed on extreme end 125 of pin end 121. For some applications, threaded portion 132, enlarged recess 50 and shoulder 128 may be formed by a single pass of a thread cutting machine (not expressly shown) starting from extreme end 126 of longitudinal bore 24 to form interior portions of box end 122. Box end 122 may have the same nominal outside diameter, inside diameter and wall thickness as tubular member 120.

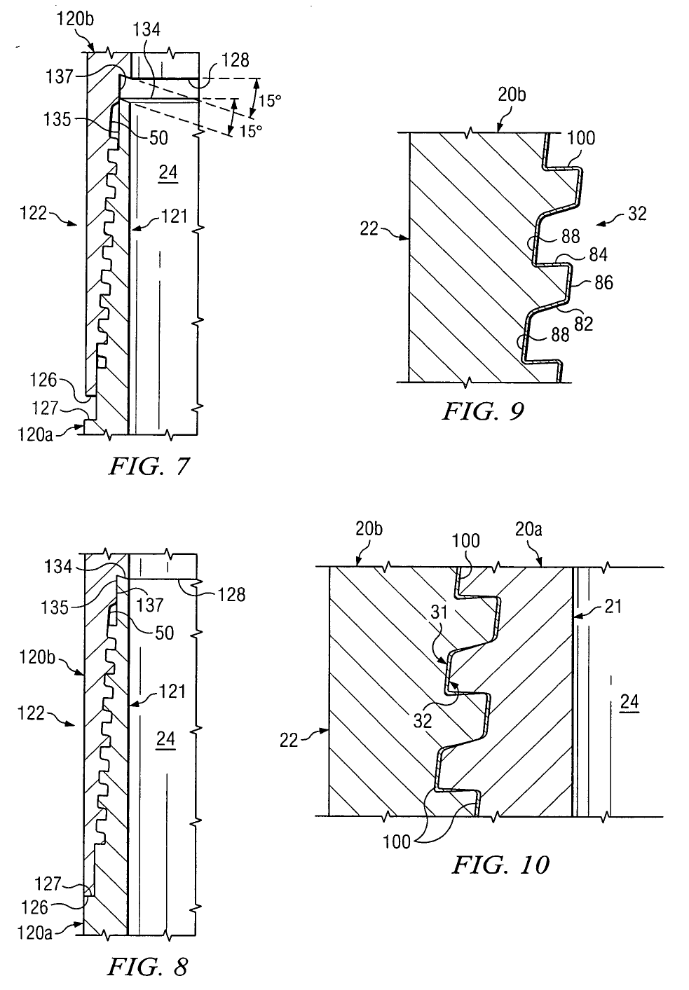

As shown in FIGS. 5A and 5B, chamfered surface 134 may be formed at extreme end 125 of pin end 121. For some applications chamfered surface 134 may extend at an angle of approximately positive fifteen degrees (+15°) relative to a plane disposed normal to longitudinal axis 23 of longitudinal bore 24. Shoulder 128 of box end 122 may be formed at an angle of approximately negative fifteen degrees (−15°) relative to a plane disposed normal to longitudinal axis 23 of longitudinal bore 24. For other applications chamfered surface 134 may be formed with a positive angle between approximately seventy-five degrees (+75°) and ninety degrees (+90°). Shoulder 128 may be formed with a generally corresponding negative angle between approximately fifteen degrees (−15°) and zero degrees (0°). As a result, when box end 122 of tubular member 120b is releasably engaged with pin end 21 of tubular member 120a, the resulting threaded connection may be described as “flush joint” with respect to the outside diameter of box end tubular member 120a and 120b and inside diameters of respective longitudinal bores 24. See FIGS. 7 and 8.

FIG. 6 shows a typical orientation of second tubular member 120b and first tubular member 120a prior to making up tubular members 120b and 120a for insertion into a wellbore (not expressly shown). The present invention allows multiple tubular members 120 to be releasably engaged with each other to form a casing string to complete a wellbore. Generally, first tubular member 120a will be positioned on a drilling platform or well servicing platform (not expressly shown) over a wellbore with pin end 121 looking up to receive box end 122 of second tubular member 120b. Various types of pipe tongs and other powered equipment associated with making and breaking threaded connections between oil country tubular goods may be satisfactorily used to releasably engage box end 122 of second tubular member 120b with pin 121 of first tubular member 120a.

Threaded portions 131 and 132 may have approximately the same length 36. Length 36 for threaded portion 131 may be measured from extreme end 125 of pin end 121 to first shoulder 127 formed on the exterior of tubular member 120. Length 36 of threaded portion 132 of tubular member 120 may be measured from extreme end 126 of box end 122 to second shoulder 128 formed on the interior of box end 122. Length 36 of threaded portions 131 and 132 may be selected so that extreme end 126 of box end 122 will abut first shoulder 127 on the exterior of pin end 121 and extreme end 125 of pin end 121 will abut second shoulder 128 of box end 122. See FIGS. 7 and 8.

Threaded connections as shown in API Specification Standard 5B may be made up to a “basic hand-tight position” and to a “basic power-tight position” as indicated by markings on the exterior of associated oil country tubular goods. The hand tight position for box end 122 of tubular member 120b relative to pin end 121 of tubular member 120a is shown in FIG. 7.

For some applications threaded portions 131 and 132 may have matching thread profiles with five (5) threads per inch. For other applications threaded portions 131 and 132 may have more than five (5) threads per inch. Various dimensions associated with threaded portions 131 and 132 of tubular members 120 may be selected to provide a hand tight position defined in part by a stand off of approximately two (2) threads between extreme end 25 of tubular member 120a and shoulder 28 of tubular member 120b. See FIG. 7.

For some applications, relatively smooth nonthreaded portion 135 may be formed as part of threaded portion 131 extending from extreme end 125 of pin end 121. Relatively smooth nonthreaded portion 137 may be formed in box end 122 between shoulder 128 and enlarged recess 50. Threaded portions 135 and 137 may be tapered to engage each other when pin end 121 and box end 122 are engaged with each other. A fluid barrier may be formed by engagement of nonthreaded portions 135 and 137 with each other.

Engagement between nonthreaded portions 135 of pin end 121 and nonthreaded portion 137 of box end 122 results in improved performance of associated threaded connections during radial expansion of tubular members 120a and 120b at a down hole location within a wellbore. When an expansion mandrel or similar tool moves through longitudinal bores 24, direct contact between nonthreaded portions 135 and 137 will result in radial expansion without disengagement of associated threaded portions 31 and 32. For some applications, nonthreaded portions 135 and 137 may have a length of approximately one (1) inch. Nonthreaded portions 135 and 137 cooperate with each other to coordinate radial expansion of pin end 121 with box end 122 during deformation of the threaded connection.

A threaded flush joint type connection formed in accordance with teachings of the present invention may have a power-tight position defined in part by extreme end 126 of box end 122 of tubular member 120b directly contacting shoulder 127 tubular member 120a and extreme end 25 of pin end 121 of tubular member 120a directly contacting shoulder 128 of box end 122 of tubular member 120b. The power-tight position for releasably engaging tubular members 120a and 120b with each other is shown in FIG. 8.

Another feature of the present invention which helps maintain desired fluid tight integrity during radial expansion includes chamfer 134 formed on extreme end 125 of pin end 121 and shoulder 128 formed within box end 122. As previously noted, shoulder 128 is preferably formed with a negative angle selected to match a corresponding positive angle associated with chamfer 134. The associated angles and the tensile strength of material used to form tubular members 120 cooperate with each other to retain close, intimate contact between extreme end 125 of pin end 121 and respective shoulder 128 of box end 122.

For some applications, a layer of tin based material or other suitable malleable material may be coated or plated on threaded portions 31 and 34. For the embodiment of the present invention as shown in FIGS. 9 and 10, coating 100 may be disposed on internal threaded portions 32 of box end 22. For purposes of illustrating various features of the present invention the thickness of coating 100 is shown larger than a typical coating on a threaded connection formed in accordance with teachings of the present invention. Modified buttress thread forms associated with threaded portions 31 and 32 and coating 100 cooperate with each other to provide improved fluid tight integrity with respect to internal fluid pressure following radial expansion of associated threaded connections. Coating 100 may be applied by various processes such as plating after threaded portion 32 has been formed in box end 22.

Various types of downhole tools such as an “expansion mandrel” (not expressly shown) may be used to radially expand tubular members 20 and 120 after being disposed at a desired downhole location in a wellbore. During a typical expansion process, pressure or force may be exerted by the expansion mandrel pressing against the inside diameter of respective pin ends 21 or 121. Resulting radial forces may be transferred to respective box ends 22 or 122 which results in radial expansion of associated box end 22 or box end 122. Such pressure and associated friction will typically cause portions of coating 100 to flow and fill any gaps or void spaces formed between respective threaded portions 31 and 32 or 131 and 132 which may occur during downhole radial expansion of associated tubular members 20 and 120. See FIG. 10.

For some applications, specifications associated with threaded portions 31 and 32 may be selected to provide approximately 0.0005 inches of clearance between respective flank angles 42 and 82 and flank angles 44 and 84 and approximately zero clearance between respective roots 48 and 88 and crests 46 and 86. During makeup of an associated threaded connection, portions of coating 100 will typically be displaced from respective flanks 82 and 84 and deposited in thread roots 48 and 88. The presence of excess coating 100 in roots 48 and 88 may result in some radial deflection of pin end 21 into longitudinal bore 24 during make up of tubular members 20a and 20b or tubular members 120a and 120b. For some applications chamfer 134 formed on pin end 121 will engage or lock with respective shoulder 128 to minimize the effects of such radial deflection. In a similar manner, negative load flank angles 44 and 84 will engage or lock with each other to also minimize the effects of such radial deflection.

For some applications pin end 21 or pin end 121 may deflect radially inward approximately 0.002 inches during power tight make of the associated threaded connection. Radial expansion of tubular members 20 and 120 at a downhole location may substantially reduce or remove any inward deflection of pin end 21.

TABLE 1
EXAMPLES OF TYPICAL DIMENSIONS FOR THREAD PROFILES

| | | | | | | End of Pipe | Length | |
|---|---|---|---|---|---|---|---|---|
| | | | | | | to | Face of | |
| | Threads | Length | | | Pitch | H | Box end | Taper |
| Size | Per | Perfect | | | Diameter at | and Tight | to Plane | Per |
| Nominal OD | Inch | Threads | E7 | L4 | E7 | Standoff | of E7 | Foot |
| 6.000 | 6 | 2.000 | 1.300 | 2.600 | 5.7155 | 0.3334 | 0.9666 | 0.750 |

| | | | BHS | | | | |
|---|---|---|---|---|---|---|---|
| | | | Pin | | C | | |
| | | | Recess | B1 | Angle of | D | E |
| Size | A | A1 | Diameter | Pin Recess | Pin Bevel | Angle of | Length to |
| Nominal | Pin Nose | Pin Nose | at | Length at | at End of | Box end | Center of |
| OD | Diameter | Length | Shoulder | Shoulder | Pipe | Shoulder | Box end |
| 6.000 | 5.570 | 0.300 | 5.830 | 0.300 | 15° | 75° | 1.000 |

| | F | F1 | | | |
|---|---|---|---|---|---|
| | Diameter of | Length of Box | G | G1 | |
| | Box end | end | Diameter of Box | Length of Box | |
| Size | Counterbore | Counterbore | end Recess at | end Recess at | K |
| Nominal | Recess at Face | Recess at Face | Center of Box | Center of Box | Wall |
| OD | of Box end | of Box end | end | end | Thickness |
| 6.000 | 5.840 | 0.300 | 5.580 | 0.300 | 0.305 |

TABLE 2
EXAMPLES OF TYPICAL DIMENSIONS FOR THREAD PROFILES
PIN - DIMENSIONS

| PIPE | ACTUAL | | | | | | | | PITCH DIA | “L7” END OF | HAND TIGHT |
|---|---|---|---|---|---|---|---|---|---|---|---|
| SIZE | O.D. | WALL | I.D. | “B” | L4 | A1 | B1 | “A” | @ E7 | PIN TO “E7” | STANDOFF |
| 5.000 | 5.025 | .296 | 4.433 | 4.865 | 2.800 | .400 | .200 | 4.5983 | 4.741 | 1.450 | .400 |
| 5.500 | 5.530 | .304 | 4.922 | 5.360 | 2.800 | .400 | .200 | 5.0933 | 5.236 | 1.450 | .400 |

BOX - DIMENSIONS

| | | | | | | | | | | “L7” END | | |
|---|---|---|---|---|---|---|---|---|---|---|---|---|
| | | | | | | | | | PITCH | OF | GREASE | HAND |
| PIPE | ACTUAL | | | | | | | | DIA @ | PIN TO | TRAP | TIGHT |
| SIZE | O.D. | WALL | I.D. | “B” | L4 | A1 | B1 | “A” | E7 | “E7” | “G” | STANDOFF |
| 5.000 | 5.025 | .296 | 4.433 | 4.5833 | 2.800 | .300 | .300 | 4.859 | 4.741 | .950 | 4.690 | .400 |
| 5.500 | 5.530 | .304 | 4.922 | 5.0783 | 2.800 | .300 | .300 | 5.354 | 5.236 | .950 | 5.185 | .400 |

NOTE:
Diameter and length dimensions in Tables 1 and 2 are in inches.

Although the present invention and its advantages have been described in detail, it should be understood that various changes, substitutions and alternations can be made herein without departing from the spirit and scope of the invention as defined by the following claims.

What is claimed is:

1. A threaded flush joint connection for releasably engaging tubular members with each other, comprising:
a first tubular member having a first, pin end and a second, box end with a longitudinal bore extending through the first tubular member between the first, box end and the second, box end;
a first tapered, external threaded portion formed on the pin end and a second tapered, internal threaded portion formed within the box end of the first tubular member;
a first shoulder formed on an exterior portion of the first tubular member;
a second shoulder formed in the box end and projecting radially into the respective longitudinal bore;
a second tubular member having a first, pin end and a second, box end with a longitudinal bore extending between the respective first, pin end and the second, box end;
a first tapered, external threaded portion formed on the pin end and a second tapered, internal threaded portion formed within the box end of the second tubular member;
a first shoulder formed on an exterior portion of the second tubular member;
a second shoulder formed on an interior portion of the box end of the second tubular member and projecting radially into the respective longitudinal bore;
each threaded portion defined in part by a thread form having a stab flank angle with a value between approximately positive ten degrees (+10°) and positive forty-five (+45°) degrees and a load flank angle with a value between approximately negative three degrees (−3°) and negative fifteen degrees (−15°);
the threaded portions cooperating with each other to provide a generally uniform outside diameter and a generally uniform inside diameter as part of the threaded connection;
respective chamfers formed on each pin end;
each chamfer having a positive angle between approximately seventy-five degrees (+75°) and ninety degrees (+90°);
each second shoulder formed with a negative angle between approximately fifteen degrees (−15°) and zero degrees (0°);
the angle of the chamfers and the angle of the second shoulders selected to allow the chamfer on the pin end of the first tubular member to securely engage the second shoulder of the box end of the second tubular member; and
the first tubular member and the second tubular member having approximately the same nominal wall thickness.

2. The threaded connection of claim 1 further comprising each stab flank angle having a value of approximately positive twenty five degrees (+25°) and each load flank angle having a value of approximately negative five degrees (−5°).

3. The threaded connection of claim 1 wherein the tubular members further comprise sections of a casing string for completion of a wellbore.

4. The threaded connection of claim 1 further comprising each tubular member formed from an electric resistance welded pipe.

5. The threaded connection of claim 1 further comprising the angle of each chamfer having a value of approximately positive fifteen degrees (+15 ) and the angle of each second shoulder having a value of approximately negative fifteen degrees (−15°).

6. The threaded connection of claim 1 wherein each box end further comprises an enlarged recess disposed between the respective second shoulder and the associated tapered, internal threaded portion.

7. The threaded connection of claim 1 further comprising a metal to metal seal formed between the chamfer of the pin end and the second shoulder of the associated box end.

8. The threaded connection of claim 1 further comprising a metal to metal seal formed between taper surfaces of the pin end and the associated box end.

9. The threaded connection claim 1 further comprising each threaded portion having a taper of approximately 0.750 inches per foot and five threads per inch.

10. The threaded connection of claim 1 further comprising each threaded portion having a taper of approximately 1.250 inches per foot and six threads per inch.

11. A threaded swage joint connection for releasably coupling tubular members with each other, comprising:
a first tubular member having a first, pin end and a second, box end with a longitudinal bore extending between the first, pin end and the second, box end;
a first tapered, external threaded portion formed on the pin end and a second tapered, internal threaded portion formed within the box end of the first tubular member;
a respective shoulder formed on an exterior portion of the first tubular member;
a second tubular member having a first, pin end and a second, box end with a longitudinal bore extending between the first, pin end and the second, box end;
a first tapered, external threaded portion formed on the pin end and a second tapered, internal threaded portion formed within the box end of the second tubular member;
a respective shoulder formed on an exterior portion of the second tubular member;
each threaded portion defined in part by a thread form having a stab flank angle with a value between approximately positive ten degrees (+10°) and positive forty-five (+45°) degrees and a load flank angle with a value between approximately negative three degrees (−3°) and negative fifteen degrees (−15°);
the box end of each tubular member sized to receive the pin end of the other tubular member;
the box end of each tubular member having an extreme end sized to engage the respective shoulder formed on the other tubular member when the pin end of one tubular member and box end of the other tubular member are releasably engaged with each other;
the second tapered, internal threaded portion of each box end extending from the respective extreme end to an enlarged recess disposed within the respective box end;
a first tapered sealing surface formed on each pin end extending from the extreme end of the respective pin end;
a second tapered sealing surface disposed on the inside diameter of each box end adjacent to the respective enlarged recess; and
the first tapered sealing surface and the second tapered sealing surface operable to be releasably engaged with each other to form a fluid barrier disposed therebetween when the external threaded portion of the pin end of one tubular member releasably engages the internal threaded portion of the box end of the other tubular member.

12. The threaded connection of claim 11 further comprising each stab flank angle having a value of approximately positive ten degrees (+10°) and each load flank angle having a value of approximately negative five degrees (−5°).

13. The threaded connection of claim 11 wherein the tubular members further comprise sections of a casing string for completion of a wellbore.

14. The threaded connection of claim 11 further comprising the tubular members formed from respective electric resistance welded pipes.

15. The threaded connection of claim 11 further comprising:
a first chamfered surface formed on an interior portion of each pin end proximate the respective extreme end; and
a second chamfered surface formed on an exterior portion of each box end proximate the respective extreme end.

16. The threaded connection of claim 11 further comprising:
the first tubular member and the second tubular member having approximately the same nominal outside diameter; and
each box end having an outside diameter larger than the nominal outside diameter of the respective tubular member.

17. The threaded connection of claim 11 further comprising:
the inside diameter of the first tubular member approximately equal to the inside diameter of the second tubular member;
the inside diameter of each pin end approximately equal to the inside diameter of the associated tubular member;
the inside diameter of each box end larger than the inside diameter of the associated tubular member;
an annular recess formed within the threaded connection proximate the extreme end of the pin end when the pin end releasably engages with the respective box end; and
the annular recess having an inside diameter larger than the inside diameter of the associated tubular members.

18. The threaded connection claim 11 further comprising each threaded portion having a taper of approximately 0.750 inches per foot and five threads per inch.

19. The threaded connection of claim 11 further comprising each threaded portion having a taper of approximately 1.250 inches per foot and six threads per inch.

20. A solid, radially expandable section of casing for using in completing a wellbore comprising:
a first radially expandable tubular member and a second radially expandable tubular member formed from electric resistance welded pipe;
the first radially expandable tubular member having a first box end and a second pin end with a longitudinal bore extending through the first radially expandable tubular member between the first box end and the second pin end;
a first internal threaded portion formed on the first box end and a second external threaded portion formed on the second pin end;
the second radially expandable tubular member having a first box end and a second pin end with a longitudinal bore extending through the second radially expandable tubular member from the first box end to the second box end;
a first internal threaded portion formed within the first box end of the second radially expandable tubular member;
a second internal threaded portion formed within the second box end of the second radially expandable tubular member;
a first shoulder disposed within the second radially expandable tubular member between the first internal threaded portion,
the first external threaded portion of the second radially expandable tubular member releasably engaged with the internal threaded portions of the first radially expandable tubular member;
the first and second external threaded portions and the first and second internal threaded portions having at least five threads per inch;
the first and second radially expandable tubular members having a hand tight position defined in part by a stand off of approximately two threads between an extreme end of the first pin member and a first shoulder of the flange; and
the first and second radially expandable tubular members having a power tight position defined in part by the extreme end of the first pin end of the first radially expandable tubular member directly abutting the first shoulder of the second radially expandable tubular member.

21. The casing section of claim 20, further comprising:
the second radially expandable tubular member having a first pin end and a second pin end with a longitudinal bore extending through the second radially expandable tubular member from the first pin end to the second pin end; and
a first external threaded portion formed on the first pin end and a second external threaded portion formed on the second pin end.

22. The casing section of claim 20, further comprising at least one of the threaded portions having a coating disposed thereon.

23. The casing section of claim 20 further comprising the threaded portion of the box end coated with a layer of tin.

24. A method of forming a radially expandable section of casing for use in completing a wellbore, comprising:
forming a first, elongated radially expandable tubular member using electric resistance welding techniques;
forming a first pin end and a second box end on the first radially expandable tubular member with a longitudinal bore extending through the first radially expandable tubular member from the first pin end to the second pin end;
forming a first tapered, exterior threaded portion on the first pin end of the first radially expandable tubular member;
forming a second, tapered exterior threaded portion on the second pin end of the first radially expandable tubular member;
forming a second, elongated radially expandable tubular member using electric resistance welding techniques;
forming a first pin end and a second box end on the second radially expandable tubular member with a longitudinal bore extending through the coupling from a first box end to a second box end;
forming a first tapered, internal threaded portion within the longitudinal bore of each box end extending from the box end to a first shoulder formed within the respective box end; and
releasably engaging the threaded portion of the second box end of the second, elongated radially expandable tubular member with the threaded portions of the pin end of the first radially expandable tubular member.

25. The method of claim 24 further comprising coating at least one of the threaded portions with a layer of material which will become malleable and flow in response to heat and pressure resulting from radial expansion of the first radially expandable tubular member and the second radially expandable tubular member to fill any gaps or void spaces formed between adjacent threaded portions.

26. The method of claim 24 further comprising forming the coating on the at least one threaded portion from a tin based material.

27. The method of claim 24 further comprising coating the first internal threaded portion and the second internal threaded portion with a tin based material.

28. The method of claim 24 further comprising:
initially engaging the second box end of the second radially expandable tubular member with the first pin end of the first radially expandable tubular member in a hand tight position defined in part by a stand off of approximately two threads between an extreme end of the first pin end and the shoulder formed within the second box end; and
securely engaging the second box end of the second radially expandable tubular member with the first pin end of the first radially expandable tubular member in a power tight position defined in part by the extreme end of the first pin end directly abutting the shoulder formed within the second box end of the second radially expandable tubular member.

29. The method of claim 24 further comprising forming the first tapered, external thread profile and the second tapered, external thread profile with matching modified buttress thread forms.

30. The method of claim 24 further comprising:
forming a chamfer on the first pin end having a positive angle of approximately fifteen degrees (+15°); and
forming a chamfer on the second pin end having a positive angle of approximately fifteen degrees (+15°).

31. The method of claim 24 further comprising forming each radially expandable tubular member from electric resistance welded pipes with approximately the same outside diameter and approximately the same inside diameter.
